(19) United States
(12) Patent Application Publication
(10) Pub. No.: US 2023/0278902 A1
(43) Pub. Date: Sep. 7, 2023

(54) IMPROVEMENTS IN RELATION TO WASTE TREATMENT

(71) Applicant: CCm Technologies Limited, Swindon (GB)

(72) Inventors: Michael Reid, Swindon (GB); Felipe Marques, Swindon (GB); Fabricio Marques, Swindon (GB); Peter Hammond, Swindon (GB)

(21) Appl. No.: 18/003,363

(22) PCT Filed: Jul. 2, 2021
(86) PCT No.: PCT/GB21/51691

§ 371 Date: Dec. 27, 2022

(30) Foreign Application Priority Data
Jul. 2, 2020 (GB) 2010188.7

(51) Int. Cl. C02F 9/00; C01B 25/45; C05B 9/00; C05B 7/00

(52) U.S. Cl. CPC C02F 9/00; C01B 25/451; C05B 9/00; C05B 7/00; C02F 2101/105

(57) ABSTRACT

A method of removing phosphates from water in a continuous process, the method comprising the steps of: (a) passing the water through a first zone in which the pH is adjusted; and (b) passing the water through a second zone in which the water is contacted with magnesium ions; wherein the water is contacted with ammonia in the first zone and/or in the second zone.

The present invention relates to methods for treating waste water, especially waste water from sewage treatment plants. In particular the invention seeks to remove phosphorous compounds, especially phosphates from water and provide a useful product.

Sewage is generally treated according to well-established processes. After settling, sewage sludge is typically treated with oxygen and bacteria to promote aerobic digestion. The resultant sludge is then fed into an anaerobic digestor. However the presence of high levels of phosphate, typically present as struvite, in the sludge can lead to the formation of inorganic residues in the digestor. This can cause blockages in pipes and other problems. Sludges are therefore treated to remove phosphates prior to anaerobic digestion using a process such as Enhanced Biological Phosphate Removal (EBPR). This is a process upstream of the sludge settling wherein phosphate accumulating organisms (PAOs) are introduced and strip much of the phosphate in the wastewater out and incorporate that in their biomass. These then settle out and are digested in the anaerobic digestion (AD) plant or pass right through and become part of the dewatered cake that emerges from the end of the treatment. The problems arise most keenly where thermal hydrolysis is used upstream of the AD plant (to improve AD efficiency) and frees up the phosphate, which then accretes on the AD plant interior, pipe bores and pump workings.

It is necessary to treat the waste water from the phosphate removal process in order to remove phosphates from this water. Current commercial processes involve the addition of ferric sulfate leading to the precipitation of ferric phosphate. However this is very atom inefficient and the phosphate present in ferric phosphate is not readily bioavailable. This limits its use in fertiliser compositions, for example. Furthermore ferric sulfate is only available from certain sources. It must therefore be transported long distances in many cases, with the result that the process is not environmentally friendly.

A number of other methods for treating these phosphate containing waste waters have been developed. However these often involve batch processes. This can limit the scale on which the processes can be carried out. Currently available methods require high capital investment and are inefficient and slow.

It is an aim of the present invention to provide an improved method for treating phosphate containing waste waters.

According to a first aspect of the present invention there is provided a method of removing phosphorus compounds from water in a continuous process, the method comprising the steps of:
(a) passing the water through a first zone in which the pH is adjusted; and
(b) passing the water through a second zone in which the water is contacted with magnesium ions;

wherein the water is contacted with ammonia in the first zone and/or in the second zone.

According to a second aspect of the present invention there is provided an apparatus for removing phosphorus compounds from water, the apparatus comprising:
water inlet means;
water outlet means;
a conduit to carry water from the inlet means to the outlet means; and
a means for collecting solid materials;

wherein the conduit is configured to carry water through at least two zones in which:
a first zone is provided with means for adjusting the pH of water passing through that zone; and
a second zone is provided with means for delivering magnesium ions into water passing through that zone;

wherein the first zone and/or the second zone is provided with means for delivering ammonia into that zone.

The first and second aspects of the invention will now be further described.

In some preferred embodiments the method of the first aspect is carried out using an apparatus of the second aspect.

The present invention relates to a method and apparatus for removing phosphorus compounds from water. Preferably the phosphorus compounds comprise phosphate ions. Preferably the invention provides a method and apparatus for removing phosphates from water.

The invention may be used to remove phosphates from any type of water. Phosphates are soluble ions which may be present in water as dissolved salts of alkali metals or other metals or as ammonium salts. Phosphates are present in high levels in human and animal waste.

In the context of this specification reference to removing phosphorus compounds or phosphates from water includes removing some or all of these compounds present in any kind of aqueous based liquid. The “water” from which the phosphorus compounds such as phosphates are removed is preferably waste water. By waste water, we mean to include any waste stream from an industrial or environmental treatment process.

In preferred embodiments the present invention is used to treat waste water comprising phosphates from the processing of sewage. In particular the invention is useful to treat waste water from sewage treatment works that include an enhanced biological phosphate removal (EBPR) step, especially when those works also include a step where the phosphate accumulating organisms (PAO) from the EBPR step are broken down to release phosphate ions into the water upstream of an anaerobic digestion process.

The method of the first aspect of the present invention is a continuous process. According to the method the water treated is passed through at least two zones. Because the process is a continuous process the water passes from the first zone to the second zone in a continuous manner. This is different to batch treatment processes of the prior art.

Continuous processes offer many advantages compared to batch processes. They are easier to implement on different scales and are much more time efficient since there are no pauses when material is transferred between vessels or when reagents are added. There are also significant cost savings associated with continuous processes compared with batch processes. A smaller vessel can deliver the same amount of product in shorter time period leading to reduced capital expenditure.

In the method of the first aspect, step (a) is preferably carried out before step (b).

The apparatus of the second aspect of the present invention includes a water inlet means and a water outlet means.

The water inlet means and water outlet means may be configured in any way suitable to direct water into and out of the conduit. Such means will be known to the person skilled in the art.

The apparatus includes a conduit through which water passes.

The conduit may take any suitable form. The conduit is suitably in the form of a channel along which the water can flow.

In some embodiments the conduit is closed. In such embodiments it is suitably not open to the atmosphere. Preferably in use when water is inside the conduit, it does not fill the conduit but there is a space above the water to accommodate air and/or other gases.

In some alternative embodiments the conduit is open.

Preferably water enters via the apparatus the inlet means, flows through the conduit and exits via the outlet means.

The conduit includes at least two zones. Preferably water flows from the first zone to the second zone. Preferably a pump is not used to transfer water between the first and second zones. There may be a dividing means between the first and second zones to slow passage of water between these zones. However in preferred embodiments water is able to flow above and/or below and/or around the dividing means. The water is suitably able to flow from the first zone to the second zone.

The apparatus includes a means for collecting solid material. This may be a tray or plate positioned on the floor of the conduit. In some embodiments the means for collecting solid material may comprise a screw conveyor. Preferably the means for collecting solid material comprises a movable belt.

The belt may be provided in one or more zones of the conduit. Suitably the movable belt passes over the lower surface of one or more zones of the conduit.

Preferably the belt is provided over the lower surface of at least the second zone.

Preferably the moveable belt extends through at least the first and second zones of the conduit. The movable belt may extend from the inlet means to the outlet means.

Preferably flow of water through the apparatus is controlled by the rate of flow into the apparatus via the inlet means and/or the rate of flow out of the apparatus via the outlet means.

In preferred embodiments the movable belt extends throughout the conduit, preferably along the lower surface of the conduit.

The conduit includes at least two zones and the method of the first aspect involves passing water through at least two zones.

In step (a) of the method of the first aspect water is passed through a first zone in which the pH is adjusted.

The conduit of the apparatus of the second aspect includes a first zone which is provided with means for adjusting the pH of water passing therethrough.

The means for adjusting the pH of the water preferably comprises means for increasing pH of the water.

Step (a) preferably comprises increasing the pH of the water.

Suitably the water delivered into the first zone has a pH of less than 7, for example from 5 to 7, suitably from 5.5 to 6.5. Adjusting the pH of the water in the first zone may comprise adding a pH adjustment agent.

Thus step (a) of the method of the first aspect may involve adding a pH adjustment agent. The first zone of the apparatus of the second aspect may comprise means for adding a pH adjustment agent.

Preferably the pH adjustment agent comprises a base. Any suitable base may be used.

A preferred base is sodium hydroxide.

In some embodiments the pH of water passing through the first zone may be adjusted by passing a gas through the water.

In some embodiments the means for adjusting the pH of water passing through the first zone comprises means for bubbling a gas through the water.

Suitably the gas displaces dissolved acidic species, for example carbon dioxide, present in the water and this leads to a change in the pH of the water. Preferably this leads to an increase in the pH of the water.

The gas bubbled through water in the first zone is suitably selected from air, nitrogen, argon or a mixture thereof.

Preferably the gas comprises air and/or nitrogen.

Preferably in step (a) of the method of the first aspect water is passed through a first zone in which gas is bubbled through the water.

The conduit of the apparatus of the second aspect preferably includes a first zone which is provided with means for bubbling air through water passing therethrough.

Any suitable means for bubbling gas, preferably air through the water in the first zone may be provided. Such means will be known to the person skilled in the art. One suitable means comprises a pipe which at one end is immersed in water and is at the other end connected to a gas supply such as an air supply. The end immersed in water comprises multiple apertures through which the gas escapes when it is blown into the pipe. In use bubbles of gas, preferably air pass through water in the first zone and pass up to the space above.

In preferred embodiments the bubbles passed through the water in the first zone have a diameter of 0.1 to 2 mm.

It is believed that the gas such as air displaces dissolved gases present in the water. This may include dissolved carbon dioxide. Dissolved carbon dioxide which increases acidity of water. Thus bubbling a gas such as air through the water suitably reduces the acidity of the water and thus increases the pH of the water.

In some embodiments the means for adjusting the pH in the first zone may comprise adding a pH adjustment agent, for example a base, to the water and bubbling a gas, for example air, through the water.

In some embodiments step (a) of the method of the first aspect may involve adding a pH adjustment agent, preferably a base, to the water and bubbling gas, preferably air through the water.

In some embodiments ammonia may be added to water passing through the first zone. The addition of ammonia will suitably affect the pH of the water in the zone.

Suitably when added in to the first zone ammonia increases the pH of the water passing therethrough.

In some embodiments the pH of water in the first zone may be adjusted, preferably increased, by the addition of an organic ash.

Organic ashes are often basic materials and thus the addition of an organic ash increases the pH of water passing through the zone.

By an organic ash we mean to refer to the ash obtained from the incineration, pyrolysis or gasification of an organic material. This may be provided by the combustion of any organic material. For example in some embodiments an organic ash may comprise the incinerated, pyrolysed or gasified waste from a water treatment plant or the ash obtained from the incineration, pyrolysis or gasification of a digestate cake obtained from an anaerobic digestion plant.

Organic ashes suitable for use in the present invention include high carbon materials commonly known as biochar.

A preferred organic ash is wood ash.

By wood ash we mean to refer to the residue remaining following the incineration, gasification or pyrolysis of wood. Any suitable source of wood ash may be used. One preferred source is the incinerated waste from wood fired power stations. The ash produced in wood fired power stations typically contains light levels of compounds which can provide nutrients to plants, such as sources of phosphorus, calcium, potassium and magnesium. Preferably the wood ash comprises metal oxides, for example calcium oxide, magnesium oxide and potassium oxide as well as carbonates, for example calcium carbonate, phosphorus oxides and phosphate compounds may also be present.

Other preferred sources of wood ash include waste from a gasification plant or waste from a pyrolysis plant.

As well as increasing the pH of water to which it is added, the organic ash will typically include some insoluble materials which will settle on the moveable belt.

This is advantageous since these insoluble materials will mix with struvite formed in the second zone. The material collected will therefore comprise further plant nutrients in addition to struvite.

Preferably the pH of the water in the first zone is adjusted to between 8 and 10, preferably to between 8.5 and 9.5, for example from 9.0 to 9.1.

Water passes from the first zone into the second zone. In the second zone the water is contacted with a source of magnesium ions.

Magnesium ions may be provided in any suitable form. A solid salt or oxide may be added or a solution or suspension of a magnesium salt or oxide may be used.

Suitably sources of magnesium ions include magnesium chloride, magnesium nitrate, magnesium sulfate and magnesium oxide.

In some embodiments powdered magnesium oxide is dosed into the water in the second zone.

Delivery of the magnesium ions into the second zone may be achieved by any suitable means. Such means will be known to the person skilled in the art.

The apparatus of the second aspect is provided in the second zone of the conduit with means for delivering magnesium ions to water passing therethrough. In some embodiments such means may comprise openings in the conduit through which solid and/or liquid reagents may be delivered.

The apparatus may include a vessel for storing a source of magnesium ions. It may further comprise measuring and dosing means.

The method of the present invention further involves contacting the water with ammonia.

Ammonia may be contacted with water in the first zone and/or the second zone.

Thus step (a) may further comprise contacting the water with ammonia and/or step (b) may comprise contacting the water with ammonia.

Ammonia may be provided in any suitable form. In some embodiments gaseous ammonia may be bubbled through the water passing through the first and/or second zone. In some preferred embodiments aqueous ammonia solution may be admixed with the water in the first and/or second zone.

In some preferred embodiments the ammonia used in the first and/or second zone may be provided by a waste stream rich in ammonia, for example waste from sewage treatment, such as from an anaerobic digester digestate dewatering process.

The first and/or second zones may be provided with means for delivering ammonia to water passing therethrough. Preferably such means are suitable for delivering a solution of ammonia.

Preferably the second zone is provided with means for delivering ammonia.

Preferably the apparatus and method are used to remove phosphates from water. This is preferably achieved by reaction of the phosphate ions present in the water with magnesium and ammonia to provide struvite. Struvite is a mineral having the formula MgNH₄PO₄·6H₂O. Preferably it is formed in the water in the second zone according to the reaction:

Mg²⁺+NH₄⁺+HₙPO₄ⁿ⁻³+6H₂O→MgNH₄PO₄·6H₂O+nH⁺

Mg²⁺+NH⁴+HₙPO₄

Suitably the water treated according to the invention is tested prior to treatment to determine the concentration of phosphate ions present in the water.

The amount of magnesium ions added in step (b) and the amount of ammonia added in steps (a) and/or (b) is determined by reference to the concentration of phosphate ions in the water.

Suitably in step (b) and optionally step (a) the ammonia and magnesium ions are added in sufficient amounts to react with substantially all phosphate ions present to produce struvite. By this we mean that the ammonia and magnesium are suitably added in the stoichiometric ratios necessary to achieve complete reaction, although conditions may mean that in some instances complete conversion is not achieved.

Preferably at least one molar equivalent of ammonium ions is added per mole of phosphate ions present.

Preferably at least one molar equivalent of magnesium ions is added per mole of phosphate ions present.

In some embodiments about 1 mole of ammonium ions is added per mole of phosphate ions present and about 1.2 moles of magnesium ions is added per mole of phosphate ions present.

The method of the first aspect may include a step of determining the concentration of phosphate ions present in the water. This step is suitably carried out before step (b). It may be carried out before, during or after step (a).

The apparatus of the second aspect may be provided with means for measuring the concentration of phosphate ions in the water before it passes into the second zone. Such means may be provided in the first zone, between the first zone and the second zone or in the region of the inlet means.

In some embodiments for example in which ammonia is provided by a waste stream, the method of the first aspect may involve a step of determining the concentration of ammonia in the source of ammonia. The apparatus of the second aspect may comprise means for determining the concentration of ammonia on the source of ammonia.

Means for measuring the concentration of phosphate ions and/or ammonium ions in an aqueous composition are known to the person skilled in the art.

Suitably during step (b) of the method of the second aspect of the present invention struvite is formed. Struvite is suitably formed in the second zone of the conduit. The struvite is insoluble and precipitates from the water. Particles of struvite suitably settle on the means for collecting solid material, such as a movable belt.

The method of the first aspect may further involve a step of collecting particles of struvite which form during the process.

These struvite particles are suitably collected and separated from the water.

Collection of the struvite particles may be achieved by any suitable means. Such means will be known to the person skilled in the art and include, for example, filtration and centrifugation.

In some embodiments the particles may be sorted by size by use of a mesh.

If necessary the struvite may be dried.

In some embodiments the method of the first aspect may further involve a step (c) of passing the water through a third zone in which gas is bubbled through the water.

In some embodiments the apparatus of the second aspect may further comprise a third zone provided with means for bubbling gas through water passing through that zone.

The apparatus of the second aspect preferably includes a movable belt. This is preferably located in at least the second zone and in preferred embodiments extends throughout the conduit. The movable belt is suitably located along the lower surface or floor of the conduit. It is suitably situated to collect solid matter that precipitates from the water. Suitably the belt moves continually while the apparatus is in use.

The surface of the movable belt is suitably configured to encourage particles of struvite to settle thereon and remain settled thereon. The belt may be made from any suitable material. Such materials will be known to the person skilled in the art and include, for example a solid rubberised belt.

In preferred embodiments the belt has a hydrophilic surface.

The belt is suitably arranged at the end of the second zone or when present the third zone of the conduit to enable the collected solid matter to be separated from the water.

For example the belt may rise from the floor of the conduit at the end of the second or third zone and carry any solid matter settled thereon out of the water. It may then be delivered to and collected in a suitable receptacle.

In some embodiments water may be agitated in the second zone, for example by a stirring blade.

In preferred embodiments the water is not mechanically agitated in the second zone other then by the flow of water into and out of the zone and by movement of the belt. Thus in preferred embodiments an additional agitation means is not provided.

To assist with collection of struvite water may be recirculated within the second zone.

The present inventors have found that recirculation of water improves the recovery of struvite.

The time in which the water is present in the second zone may be controlled by managing the flow of water through the apparatus. Suitably up to 80% of the phosphate present in the water may be recovered if water is retained in the second zone for about one hour.

Step (c) when present is preferably carried out after step (b).

In some embodiments when the method includes step (c) a heating step may be included between steps (b) and (c) or during step (c).

In preferred embodiments such a heating step is carried out before step (c).

Thus in preferred embodiments in the method of the first aspect of the present invention step (a) is carried out first, followed by step (b), then an optional heating step and finally step (c).

In some embodiments the method of the first aspect may involve a step after step (b) heating the water. This optional heating step may be carried out between step (b) and step (c) and/or during step (c). Preferably when used the heating step is carried out between step (b) and step (c).

Typically the water to be treated is provided in step (a) at ambient temperature. This temperature may be from 5 to 30° C., suitably from 10 to 25° C., preferably from 15 to 35° C., for example around 18 to 20° C.

When the method of the first aspect includes a heating step the temperature of the water is preferably increased by at least 5° C., preferably by at least 10° C., for example by 15° C. or more.

In such embodiments the water is preferably heated to a temperature of at least 25° C., preferably at least 30° C., suitably at least 35° C., for example at least 40° C.

In some embodiments the water may be heated up to 90° C., preferably up to 80° C., suitably up to 70° C., preferably up to 60° C., for example up to 55° C. or up to 50° C.

Preferably the water is heated to a temperature of 30 to 60° C., preferably 35 to 55° C., suitably 40 to 50° C., for example about 45° C.

When the method of the present invention includes a heating step this preferably involves using heat energy produced as a by-product in another process.

In some embodiments the apparatus of the second aspect is provided with heating means configured to provide heated water to the third zone.

Any suitable heating means may be provided. Such means will be known to the person skilled in the art and include, for example, a heated coil or plate which is immersed in the water.

Suitably the heating means, when present, is located between the second zone and the third zone and/or within the third zone.

Preferably the heating means is located between the second zone and the third zone.

Step (c) of the method of the first aspect when present involves passing the water through a third zone in which gas is bubbled through the water.

In some embodiments step (c) involves passing the water through a third zone in which gas is bubbled through heated water.

The gas bubbled through water in the third zone is suitably selected from air, nitrogen, argon or a mixture thereof.

Preferably the gas comprises air and/or nitrogen.

In some especially preferred embodiments the gas provided in the third zone comprises nitrogen.

Any suitable means for bubbling a gas, such as nitrogen, through the water in the third zone may be provided. Such means will be known to the person skilled in the art.

Gas is bubbled through the water in the third zone to displace dissolved ammonia which may be still present in the water.

The gas bubbles through the water and escapes along with ammonia into the space within the conduit above the water passing through the third zone. This ammonia enriched air may be collected and the ammonia recovered and reused in the process.

Water treated according to the method of the first aspect of the present invention is suitably tested to measure the concentration of phosphate and optionally other contaminants after step (d) before being released to a water course. If phosphate levels are too high, the water may be recirculated and the process repeated.

The apparatus of the second aspect may be provided with means for measuring the concentration of phosphate ions present in the water leaving the third zone. The apparatus may further comprise means to analyse this measurement, and based on this analysis, direct the water to exit the apparatus or to be recirculated, depending on the result obtained.

The provision of such measures will be within the competence of the skilled person.

In preferred embodiments ammonia enriched gas from the conduit is collected and the ammonia is recovered and reused in the process.

Methods of recovering ammonia will be known to the skilled person.

In one preferred recovery process very small bubbles of the ammonia-enriched gas, typically having a diameter of 1 to 100 microns, preferably 1 to 25 microns are passed through chilled water. The water preferably has a temperature of 10 to 15° C. When bubbles of this size are provided in water at this temperature, the vapour pressure of ammonia means that it dissolves in the water. Thus ammonia is removed from the gas to form an ammonia solution and clean gas. The ammonia solution can be reused in steps (a) and/or (b).

The present invention provides a method of removing phosphate from water. The method produces struvite. Struvite is a useful product which can be used in fertiliser compositions and provides phosphorous in a readily bioavailable form.

A particular advantage of the present invention is that it can make use of multiple waste materials obtained during a water treatment process.

In particular the invention can utilise multiple products from the anaerobic digestion of water. Preferably the invention is used to treat waste water from a sewage treatment process that include an enhanced biological phosphate removal step.

Preferably ammonia used in the invention is provided by a waste stream, suitably from an anaerobic digester digestate dewatering process.

Adjustment of the pH of the water in the first zone may be achieved by the addition of an organic ash produced by the incineration and/or gasification and/or pyrolysis of the digestate cake from an anaerobic digestor.

The use of the multiple waste sources in a single process is highly beneficial. The product obtained comprises struvite admixed with further mineral-rich solids from the organic ash. This is a highly beneficial plant nutrient material.

Because struvite is not water soluble it is a very useful material for inclusion in fertilisers. The phosphates in struvite are not readily washed away and are thus retained at or just below the surface of the soil and are readily available to the roots of a plant.

The inclusion of an organic ash provides further plant nutrients such as potassium, phosphorus, calcium, magnesium, sulfur and other micro nutrients.

This invention will now be further described with reference to the accompanying drawings in which:

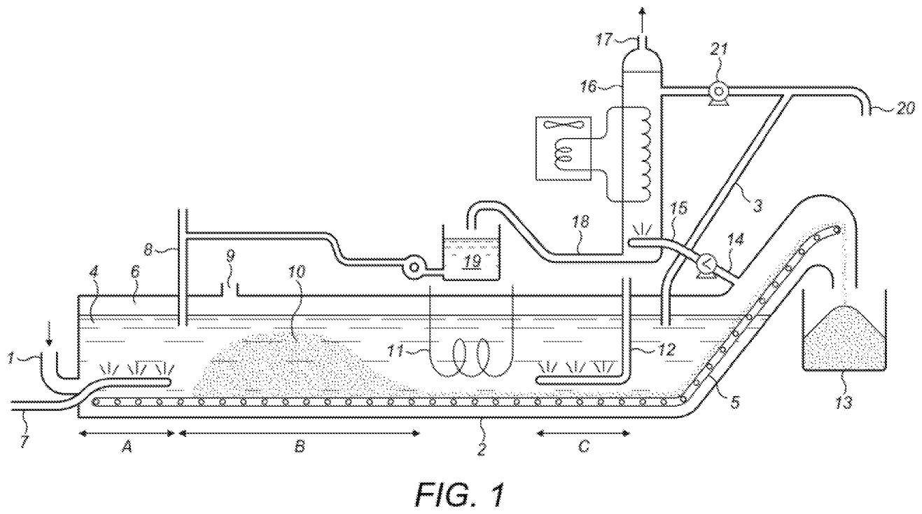

FIG. 1 shows an apparatus of the second aspect which includes a third zone;

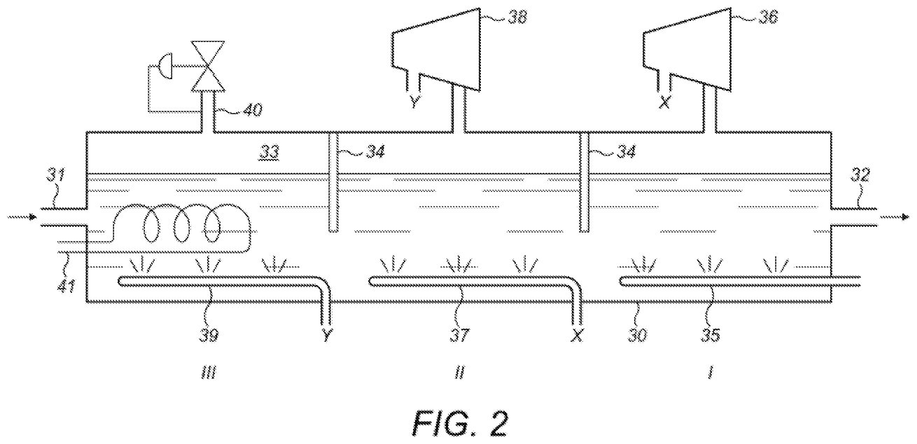

FIG. 2 is an enlarged view of the ammonia recovery unit show in FIG. 1;

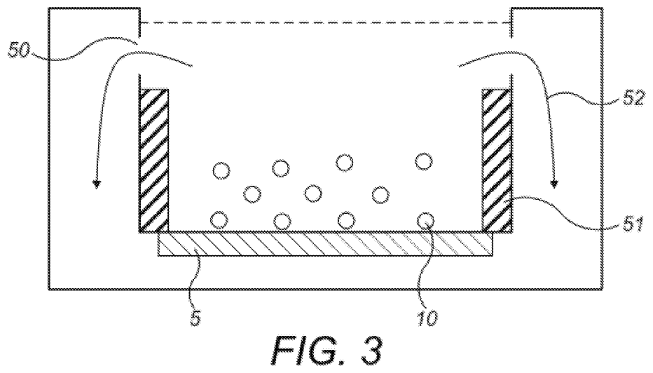

FIG. 3 is a cross sectional view of the second zone B of the apparatus of FIG. 1; and

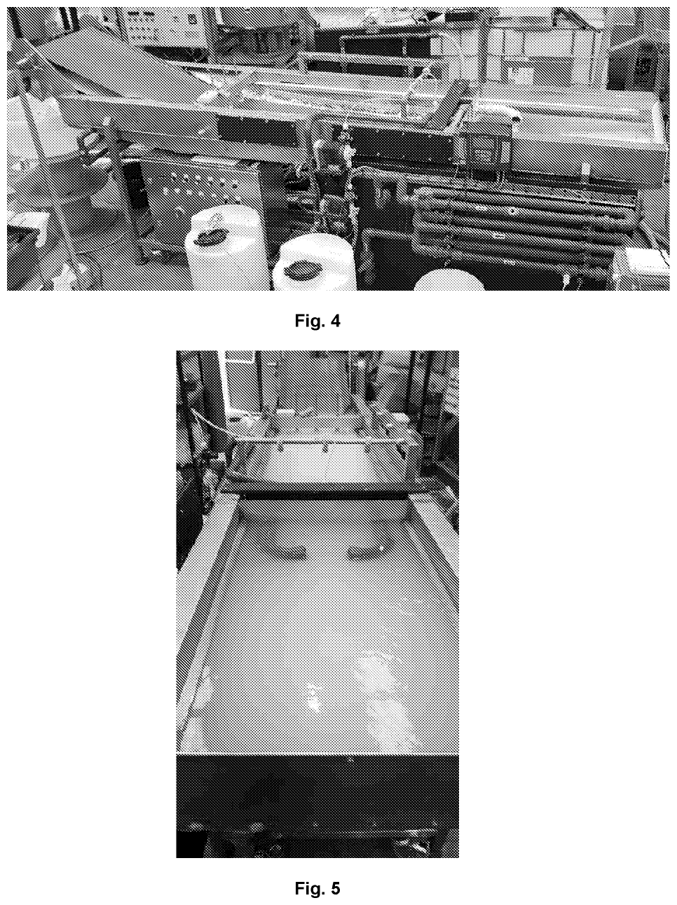

FIGS. 4 to 19 are photographs of an apparatus of the invention in use.

Water is directed into the apparatus of the invention includes via the water inlet means 1. This may be closable by a tap or valve.

The water 4 passes along the conduit 2 and exits via the water outlet means 3.

The water passes through the conduit through a first zone A, a second zone B and a third zone C.

A movable belt 5 extends along the conduit. The flow of water into the conduit is controlled to ensure a headspace 6 for air and other gases.

Air is blown into the first zone A via pipe 7.

The water then passes into the second zone B.

Ammonia solution is dosed into the water via pipe 8 and magnesium oxide is delivered via inlet 9. This leads to the formation of struvite particles 10 which precipitate and settle onto belt 5.

A part of this zone of the apparatus is shown in cross section in FIG. 3. Struvite particles 10 settle on belt 5. Rubber seals 51 stop the water from leaking below the belt. The walls of the conduit include cut out overflow portions 50 through which water in the upper region of the zone can drain as indicated by arrows 52. This water is collected and recirculated into zone B, for example via addition to pipe 9.

The water is heated by heating coil 11 from about 20° C. when it is in the second zone to about 45° C. in the third zone C. In the third zone C air is bubbled through the water via pipe 12. The struvite carried on the belt is lifted out of the water after the third zone and deposited in receptable 13.

Ammonia and nitrogen or air in the headspace are directed via outlet 14 and pipe 15 into the ammonia recovery unit 16 which removes ammonia from the nitrogen and air giving a stream 17 that may be recirculated back through zone C; and ammonia solution 19 via pipe 18. The ammonia solution may also be reused in the process.

Water exiting may be directed to a water course via outlet 20 or to the ammonia recovery unit via valve 21.

The ammonia recovery unit shown in FIG. 2 includes a conduit 30 through which water flows entering by inlet 31 and exiting via outlet 32.

The water is chilled to around 15° C. by chiller coil 41. There is a headspace 33 for gases. This is divided into sections by partitions 34 which extend across the headspace but not fully through the depth of the water.

Ammonia enriched air from the headspace 6 in the struvite formation apparatus is directed into a first section I via pipe 35. The pipe is configured to provide bubbles having a diameter of 1 to 100 microns, preferably 1 to 25 microns. These pass through the liquid. Gases from the headspace above section I are compressed using compressor 36.

The compressed gases X are then directed into pipe 37 which delivers bubbles having a diameter of 1 to 100 microns, preferably 1 to 25 microns into section II. A second compressor 38 delivers gases Y into a third section III via pipe 39.

Clean air exits via outlet 40 and an approximately 20% ammonia solution is provided via outlet 32.

The skilled person will appreciate that the number of sections in the ammonia recovery unit may be varied.

FIG. 4 is a photograph of an apparatus of the invention including first and second zones. The first zone is closest to the camera in FIG. 5 and the belt can be seen rising out at the end past the second zone.

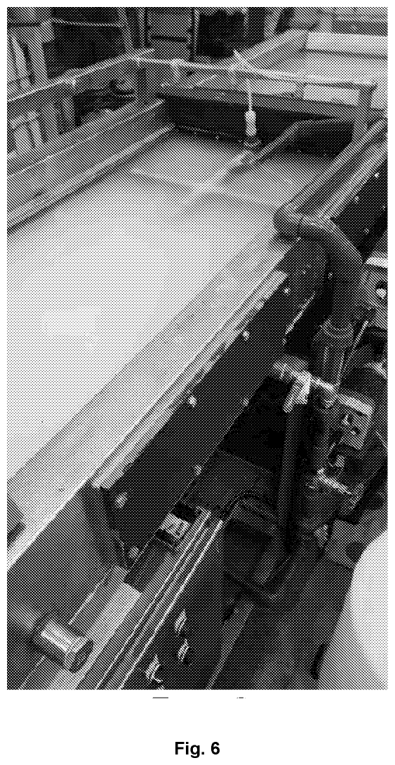

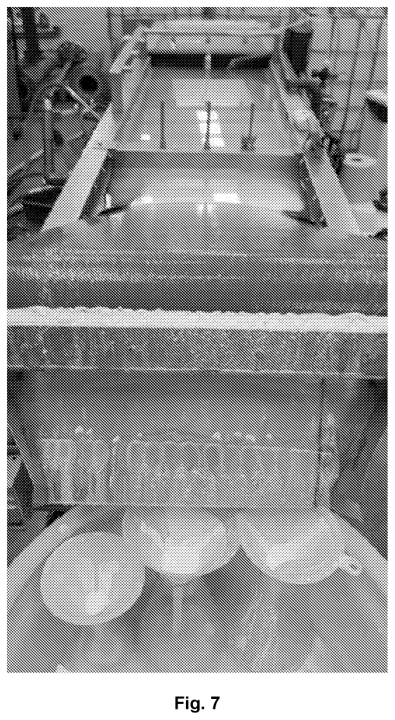

FIG. 6 is a photograph of the second zone and FIG. 7 shows the means for collecting the struvite.

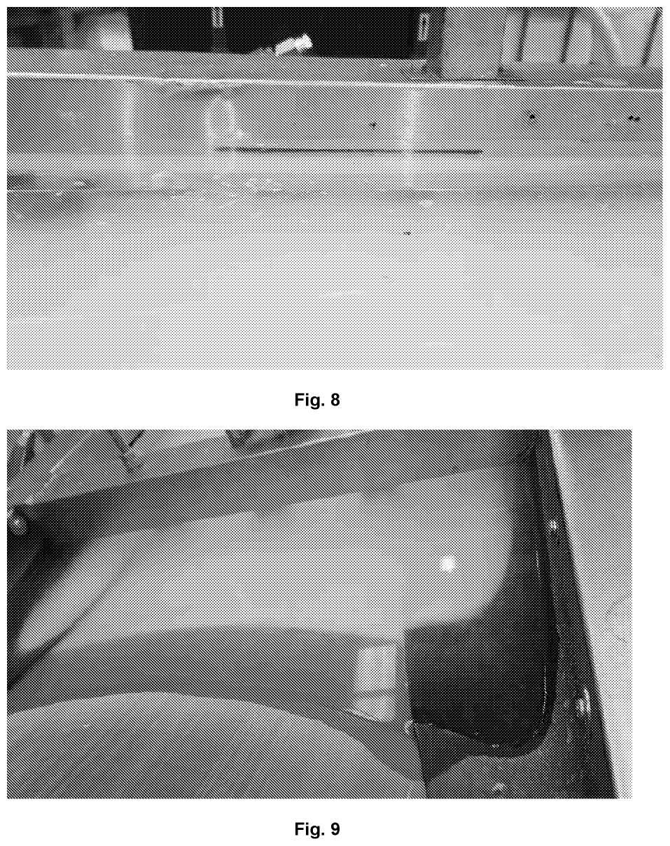

FIG. 8 shows an overflow slot in the side of the wall of the second zone.

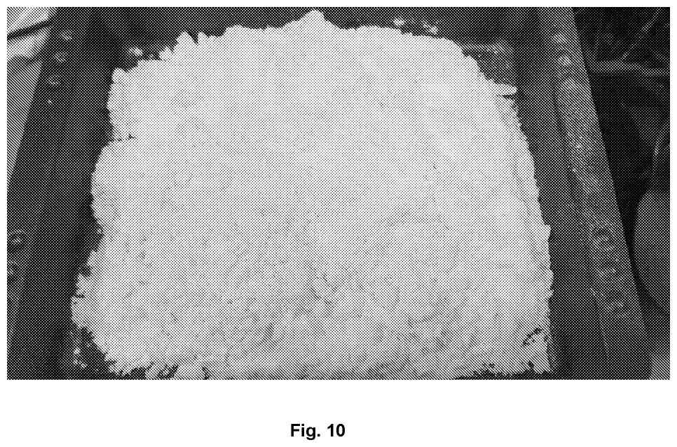

FIG. 9 shows struvite settled on the belt and FIG. 10 shows collected struvite which has been dried in an oven.

1. A method of removing phosphates from water in a continuous process, the method comprising the steps of:
(a) passing the water through a first zone in which the pH is adjusted; and
(b) passing the water through a second zone in which the water is contacted with magnesium ions;
wherein the water is contacted with ammonia in the first zone and/or in the second zone.

2. The method according to claim 1, wherein the water is waste water from an industrial or environmental process.

3. The method according to claim 1, wherein the water provided is from a sewage treatment process; preferably from a sewage treatment process which includes an enhanced biological phosphate removal step.

4. The method according to claim 1, wherein the pH is increased in step (a).

5. The method according to claim 1, wherein a pH adjustment agent is added in step (a); preferably wherein the pH adjustment agent comprises sodium hydroxide.

6. The method according to claim 1, wherein a gas is bubbled through the water in step (a); preferably wherein the gas is air.

7. The method according to claim 1, wherein the pH of the water passing through the first zone is increased by the addition of an organic ash.

8. The method according claim 1, wherein the ammonia is provided as an ammonia solution.

9. The method according to claim 1, wherein the ammonia is provided by a waste stream rich in ammonia; preferably from an anaerobic digester digestate dewatering process.

10. The method according to claim 1, wherein the magnesium ions are provided by magnesium oxide and/or magnesium sulfate.

11. The method according to claim 1, which further includes a step passing the water through a third zone in which gas is bubbled through the water.

12. The method according to claim 1, which includes a heating step between step (b) and step (c) and/or during step (c).

13. The method according to claim 1, which includes a step (d) of collecting particles of struvite which form during the process.

14. The method according to claim 1, which includes a step before step (b) of determining the concentration of phosphate ions present in the water.

15. The method according to claim 14, wherein in step (b) the ammonia and magnesium ions are added in sufficient amounts to react with substantially all of the phosphate ions present to produce struvite.

16. An apparatus for removing phosphates from water, the apparatus comprising:
water inlet means;
water outlet means;
a conduit to carry water from the inlet means to the outlet means; and
a means for collecting solid materials;
wherein the conduit is configured to carry water through at least two zones in which:
a first zone is provided with means for adjusting the pH of water passing through that zone; and
a second zone is provided with means for delivering magnesium ions into water passing through that zone;
wherein the first zone and/or the second zone is provided with means for delivering ammonia into that zone.

17. The apparatus according to claim 16, wherein the means for adjusting the pH in the first zone comprises means for delivering a pH adjustment agent to water passing through that zone and/or means for bubbling gas through water passing through that zone.

18. The apparatus according to claim 16, which further comprises a third zone is provided with means for bubbling gas through water passing through that zone

19. The apparatus according to claim 18, which includes heating means configured to provide heated water to the third zone.

20. The apparatus according to claim 17, wherein the means for collecting solid materials comprises a movable belt or wherein the means for collecting solid materials comprises a screw conveyor.

21. (canceled)
